(19) United States
(12) Patent Application Publication
(10) Pub. No.: US 2008/0149424 A1
(43) Pub. Date: Jun. 26, 2008

(54) ADJUSTING STRUCTURE FOR AN OIL FEEDING DEVICE OF A LINEAR GUIDEWAY

(76) Inventors: Jen-Sheng Chen, Taichung (TW); Hsing-Liang Chen, Taichung (TW)

Correspondence Address: Dr. BANGER SHIA, 102 Lindencrest Ct., Sugar Land, TX, 77479-5201, US

(21) Appl. No.: 11/615,981

(22) Filed: Dec. 24, 2006

(51) Int. Cl. F16N 21/02

(52) U.S. Cl. 184/105.3

(57) ABSTRACT

An adjusting structure for an oil feeding device of a linear guideway comprises: an oil scraping piece, an end cap, a cover plate and an oil nozzle seat. The oil nozzle seat is provided for positioning an oil nozzle, and the oil nozzle seat is fixed on the end cap. The second positioning portion of the oil nozzle cooperates with the first positioning portion of the end cap to enable the oil nozzle seat to be movable or rotatable or positioned relative to the end cap, allowing the user to adjust the feeding angle of the oil nozzle.

### BACKGROUND OF THE INVENTION

1. Field of the Invention

The present invention relates to a linear guideway, and more particularly to an adjusting structure for an oil feeding device of a linear guideway.

2. Description of the Prior Art

A conventional end cap (P1) for a linear guideway (as shown in FIG. 1) is formed in a side of the mid portion thereof with a threaded hole P11 in which an oil nozzle A is to be screwed. The threaded hole P11 is directly formed in the end cap P1, however, it still has the following disadvantages:

A, forming the threaded hole P11 requires the use of a tapping machine, and the tapping machine is unable to fix the initial angle of the threads of the threaded hole P11 at the same position. When the oil nozzle A is threaded in the threaded hole P11, the feeding angle of the nozzle A is fixed and cannot be adjusted according to user's requirement.

B, the tapping machine occupies a certain amount of mould space, and accordingly the cooling passage must be reduced or cancelled, so that it is unable to use the cooling passage to effectively cool down the mould, resulting in a temperature increase of the mould, and the structure of the end cap P1 is likely to be deformed.

To effectively solve the aforementioned problems, the inventor of the present invention, on the basis of the accumulated experience and skills associated with the linear transmission field, has developed a brand new an adjusting structure for an oil feeding device of a linear guideway.

### SUMMARY OF THE INVENTION

The primary objective of the present invention is to provide an adjusting structure for an oil feeding device of a linear guideway, wherein the feeding angle of the oil nozzle can be adjusted by the oil nozzle seat and the end cap.

To obtain the abovementioned objective, an adjusting structure for an oil feeding device of a linear guideway in accordance with the present invention comprises: an end cap and an oil nozzle seat. The oil nozzle is adjusted by the second positioning portion of the oil nozzle and the first positioning portion of the end cap, and the oil nozzle seat to be movable or rotatable or positioned relative to the end cap, allowing the user to adjust the feeding angle of the oil nozzle.

The secondary objective of the present invention is to provide an adjusting structure for an oil feeding device of a linear guideway, wherein the end cap has a space large enough to accommodate cooling passage, thus providing a better cooling effect.

To obtain the abovementioned objective, an adjusting structure for an oil feeding device of a linear guideway in accordance with the present invention comprises: an end cap and an oil nozzle seat. With the cooperation of the oil nozzle seat and the end cap, the thread structure can be reduced, so that the end cap will have a great enough space to accommodate the cooling passage, thus reducing the high-temperature caused deformation of the end cap.

### BRIEF DESCRIPTION OF THE DRAWINGS

FIG. 1 is an illustrative view of showing a conventional end cap;

FIG. 2 is an illustrative view of an adjusting structure for an oil feeding device of a linear guideway in accordance with the present invention;

FIG. 3 is an exploded view of an adjusting structure for an oil feeding device of a linear guideway in accordance with the present invention;

FIG. 4 is an illustrative view of an end cap in accordance with the present invention;

FIG. 5 is an illustrative view of a cover plate in accordance with the present invention;

FIG. 6A is a perspective view of an oil nozzle seat in accordance with the present invention;

FIG. 6B is another perspective view of the oil nozzle seat in accordance with the present invention;

FIG. 6C is a side view of the oil nozzle seat in accordance with the present invention;

FIG. 7 is a perspective view in accordance with the present invention of showing an oil nozzle seat formed on its second positioning portion with a single tooth;

FIG. 8 is a front view of an adjusting structure for an oil feeding device of a linear guideway in accordance with the present invention;

FIG. 9 is a cross sectional view of the adjusting structure for an oil feeding device of a linear guideway in accordance with the present invention;

FIG. 10 is a perspective view of an adjusting structure for an oil feeding device of a linear guideway in accordance with another embodiment of the present invention;

FIG. 11A is a perspective view of an oil nozzle seat in accordance with another embodiment of the present invention;

FIG. 11B is another perspective view of the oil nozzle seat in accordance with another embodiment of the present invention; and

FIG. 12 is a perspective view of an oil nozzle seat in accordance with a third embodiment of the present invention.

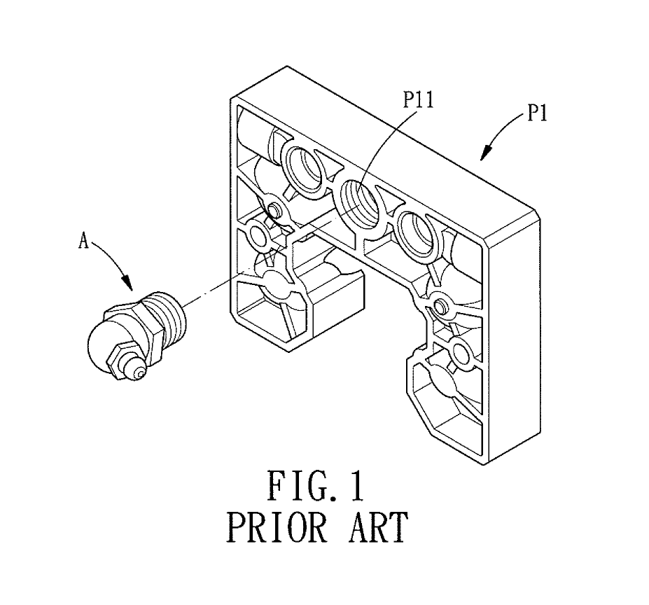

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

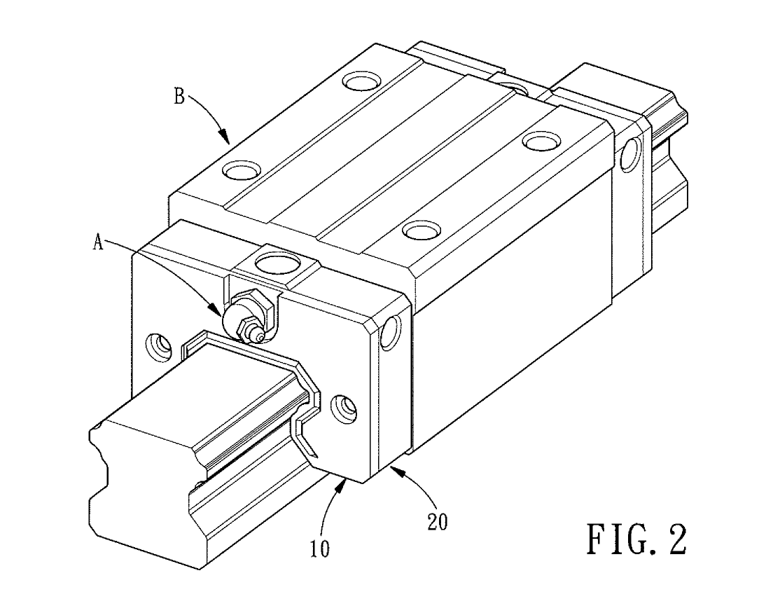

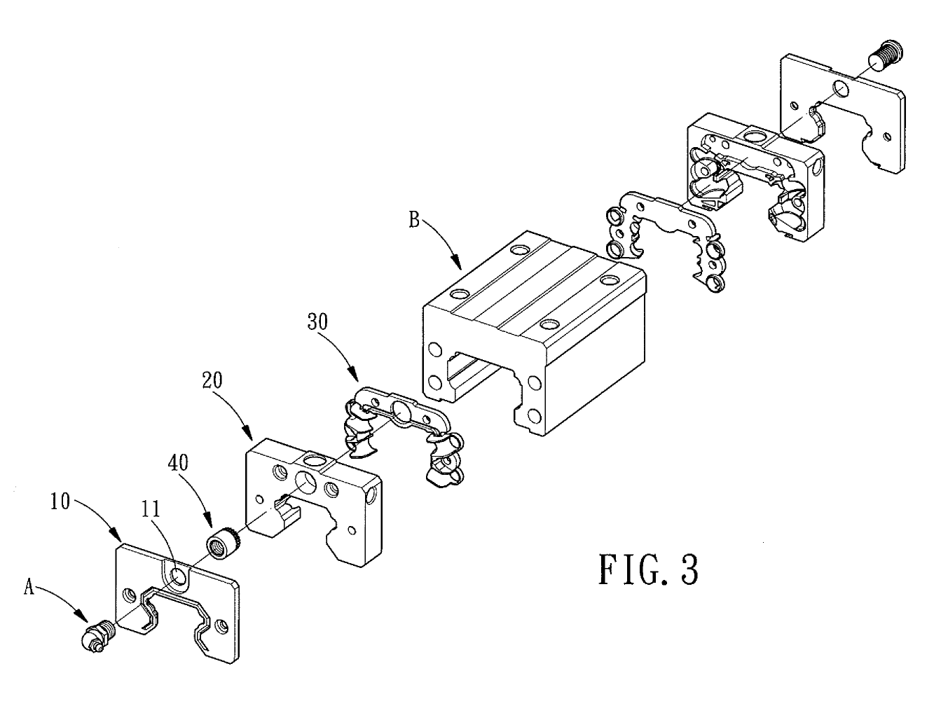

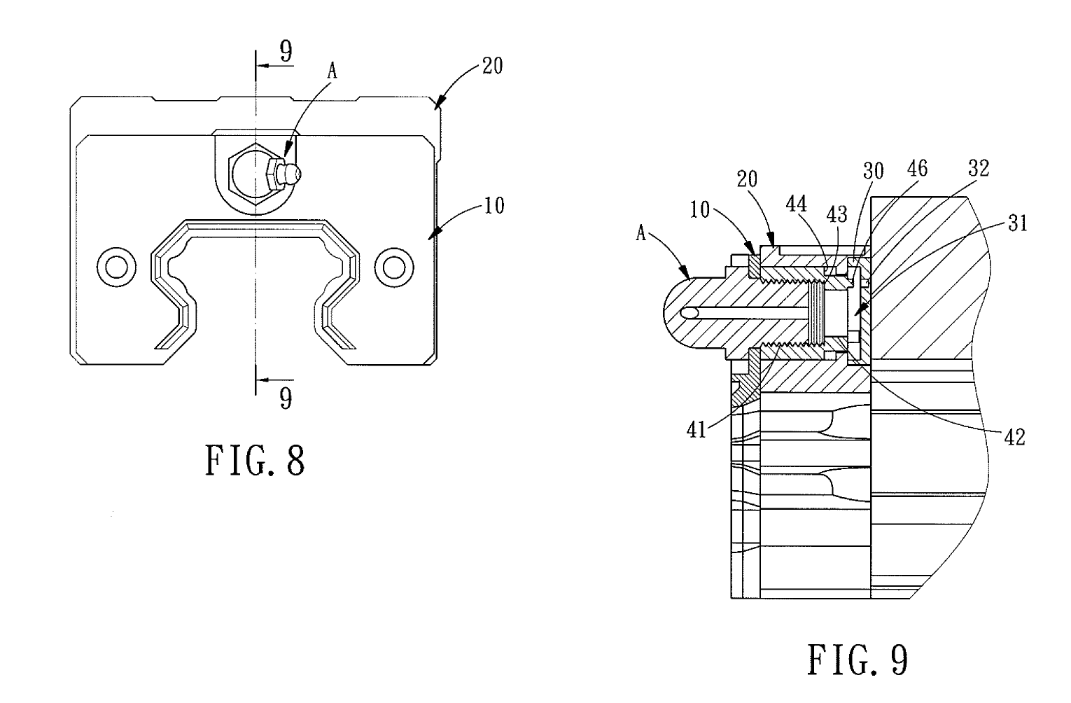

FIG. 2 shows a preferred embodiment of the present invention (meanwhile, with reference to FIGS. 3-12).

An adjusting structure for an oil feeding device of a linear guideway in accordance with the present invention comprises: an oil scraping piece 10, an end cap 20, a cover plate 30, and an oil-nozzle seat 40. The oil scraping piece 10, the end cap 20, and the cover plate 30 are sequentially assembled on a slide block B (as shown in FIGS. 2 and 3).

The oil scraping piece 10 (as shown in FIG. 3) is formed in the top side thereof with a through hole 11.

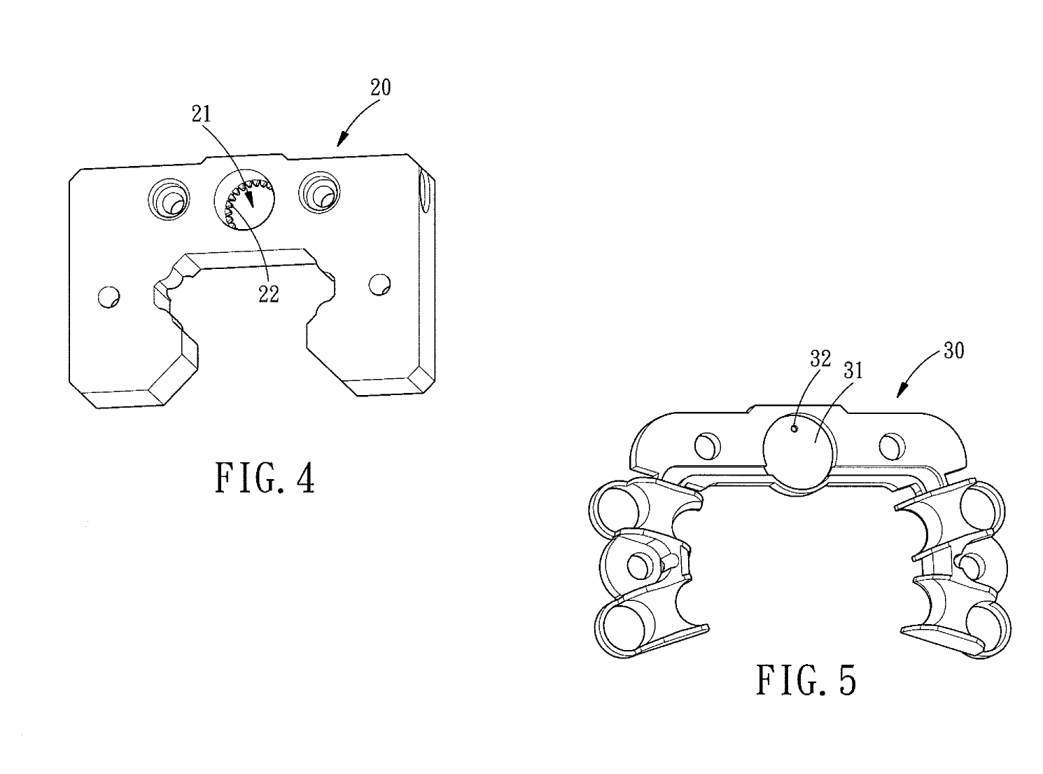

The end cap 20 (as shown in FIG. 4) is formed in the top side thereof with a through hole 21 to be aligned with the through hole 11 of the oil scraping hole 10. At one end of the through hole 21 is radially formed a first positioning portion 22 that includes a plurality of tooth-shaped portions annularly arranged around the through hole 21. The thickness of the first positioning portion 22 is H, and a length between an end surface of the through hole 21 and the side surface of the first positioning portion 22 is L.

The cover plate 30 (as shown in FIG. 5) is formed in its top surface with a concave 31, and in a bottom of the concave 31 is formed a positioning hole 32. The concave 31 of the cover plate 30 is aligned with the through hole 21 of the end cap 20.

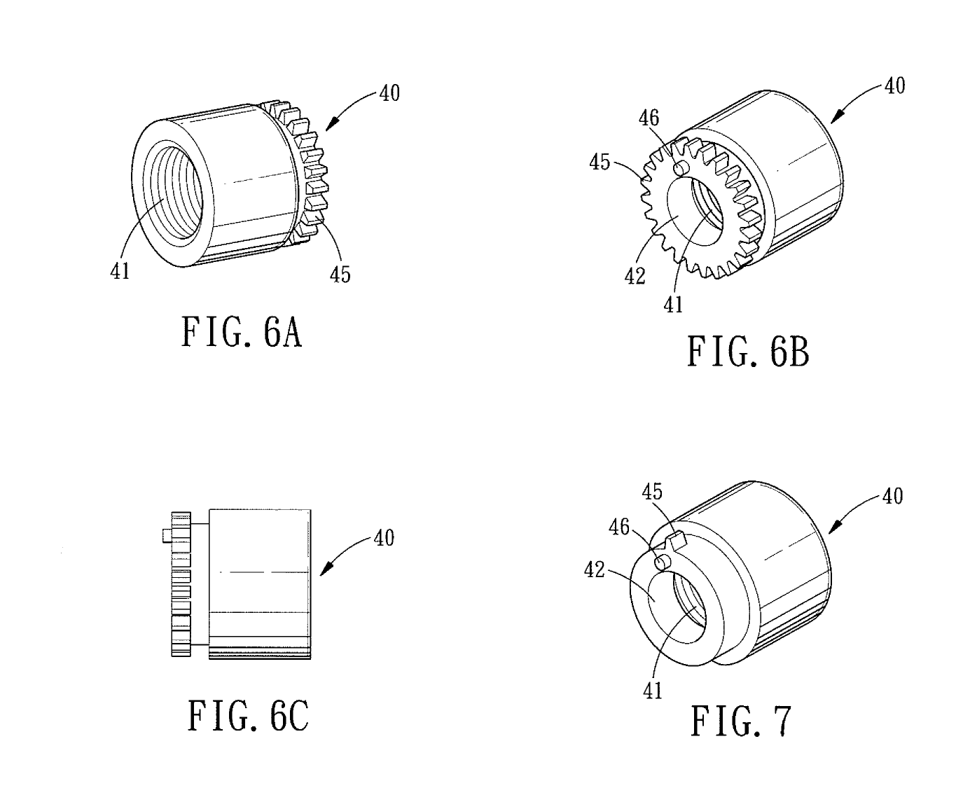

The oil nozzle seat 40 (as shown in FIG. 6A-C) is a stepped columnar structure. In one end of the interior of the oil nozzle seat 40 is formed a threaded hole 41 with a comparatively large inner diameter, and in the other end of the interior of the oil nozzle seat 40 is formed a connecting hole 42 with a comparatively small inner diameter. The threaded hole 41 is provided for engaging with the oil nozzle A. At the connecting portion between the threaded hole 41 and the connecting hole 42 is formed a stopping surface 43. The oil nozzle seat 40 is formed on its outer periphery with an abutting surface 44. A length from an end surface of the oil nozzle seat 40 to the stopping surface 43 is L1. At one end of the oil nozzle seat 40 is radially formed a second positioning portion 45 formed in the shape of the first positioning portion 22 of the end cap 20. The thickness H of the second positioning portion 45 is equal to the thickness H of the first positioning portion 22. One side surface of the second positioning portion 45 of the oil nozzle seat 40 is located a specific distance L2 away from the abutting surface 44, on the other side surface of the second positioning portion 45 of the oil nozzle seat 40 is formed an axial positioning rib 46 formed in the shape of the positioning hole 32 of the cover plate 30.

FIG. 7 shows another embodiment of the oil nozzle seat, wherein the second positioning portion of the nozzle seat is formed with a single tooth, and the second positioning portion 45 of the nozzle 40 is formed in the shape of the single-tooth shaped first positioning portion 22 of the end cap 20.

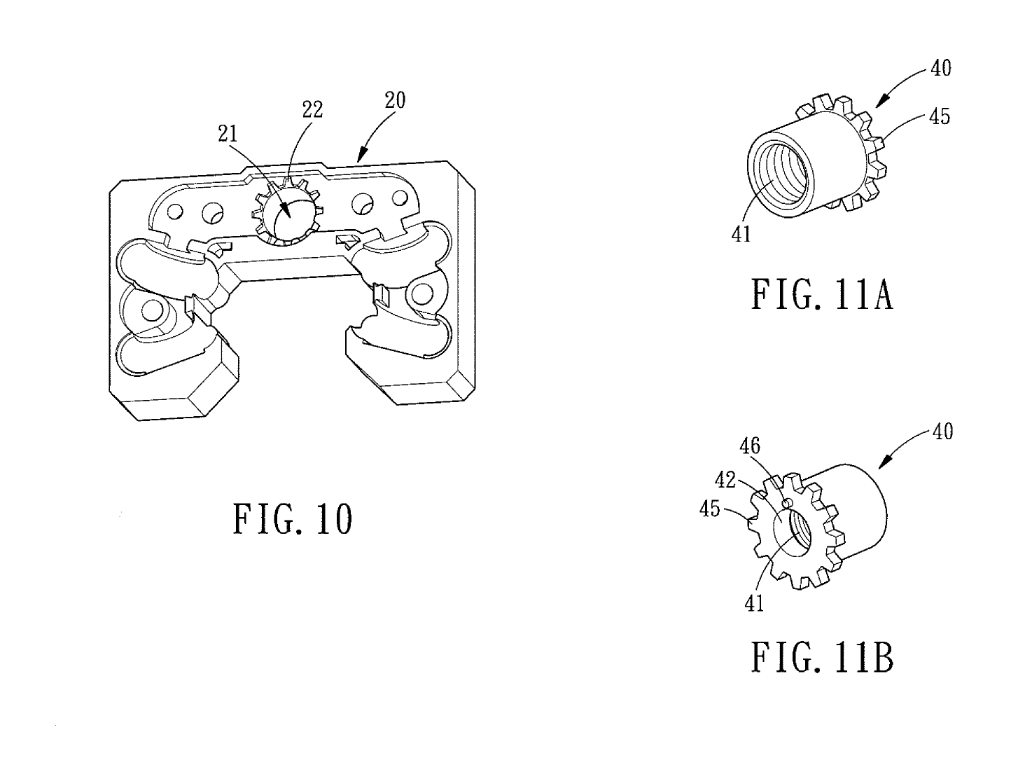

FIG. 10 shows another embodiment of the end cap in accordance with the present invention (meanwhile, with reference to FIGS. 11A-11B), the first positioning portion 22 is a tooth-shaped groove annularly formed in a side surface of the end cap 20 and is aligned to the through hole 21 of the end cap 20 and the concave 31 of the cover plate 30. The oil nozzle seat 40 is a stepped columnar structure, the second positioning portion 45 of the oil nozzle seat 40 is formed on one end of the oil nozzle seat 40 and is formed in the shape of the first positioning portion 22 of the end cap 20.

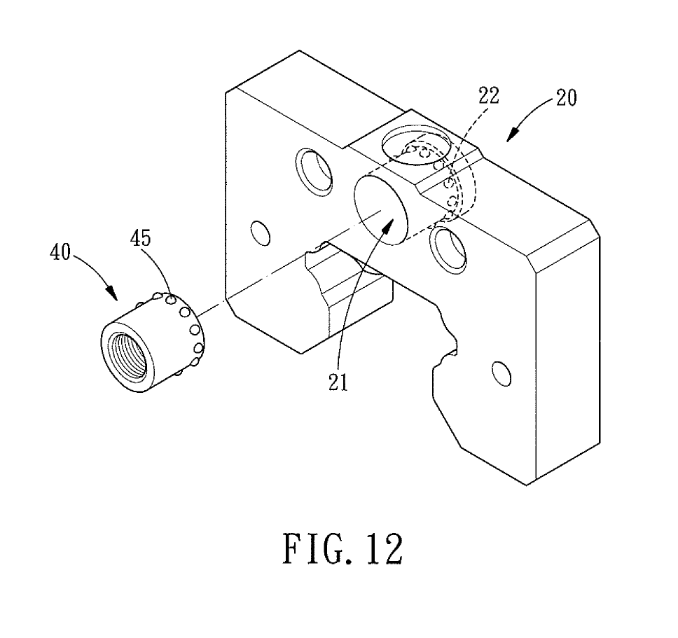

FIG. 12 shows another embodiment of the oil nozzle seat of the present invention, the first positioning portion 22 of the end cap 20 is formed at one end of the through hole 21 and includes a plurality of semi-circular cavities annularly arranged around the through hole 21. The oil nozzle seat 40 is a columnar structure, and the second positioning portion 45 of the oil nozzle seat 40 is formed on one end of the oil nozzle seat 40 and is formed in the shape of the first positioning portion 22 of the end cap 20.

For a better understanding of the present invention, its operation and function, reference should be made to FIGS. 3-9.

In assembly, the through hole 21 of the end cap 20 and the concave 31 of the end cap 30 are aligned to each other and are fixed to an end of the slide block B. The oil nozzle seat 40 is inserted in the through hole 21 of the end cap 20. And then the through hole 11 of the oil scraping piece 10 is aligned to the through hole 21 of the end cap 20, so that an end surface of the oil nozzle seat 40 is positioned and stopped against the oil scraping piece 10, and the other end surface of the oil nozzle seat 40 is located a certain distance 13 away from the bottom of the concave 31 of the cover plate 30. L3 is equal to or larger than L2, and L3 and L2 are larger than or equal to the thickness H of the first positioning portion 22 of the end cap 20 and the second positioning portion 45 of the oil nozzle seat 40. The abutting surface 44 of the oil nozzle seat 40 is positioned and restricted by the first positioning portion 22 of the end cap 20, and the oil nozzle A is inserted in the through hole 11 of the oil scraping piece 10 and is threaded in the threaded hole 41 of the oil nozzle seat 40.

When the feeding angle oil nozzle A doesn't meet the user's requirement, the user can unscrew the oil nozzle A, so that the specific distances L2 and L3 allow the oil nozzle seat 40 to move within the through hole 21 of the end cap 20 and the concave 31 of the cover plate 30, and the oil nozzle A and the oil nozzle seat 40 are pushed into the concave 31 of the cover plate 30, as a result, the second positioning portion 45 of the oil nozzle seat 40 is disengaged from the first positioning portion 22 of the cover plate 20. At this moment, the oil nozzle A and the oil nozzle seat 40 can be rotated to a desired angle, and after that, the user can screw the oil nozzle A and the oil nozzle seat 40 until they are stopped against the stopping surface 43, so that the second positioning portion 45 of the oil nozzle seat 40 is engaged with the first positioning portion 22 of the end cap 20, thus restricting the rotation of the oil nozzle seat 40.

To disassemble the oil nozzle A, the user can unscrew the oil nozzle A and push the oil nozzle A and the oil nozzle seat 40 to the bottom of the concave 31 of the cover plate 30, so that the positioning rib 46 of the oil nozzle seat 40 is engaged in the positioning hole 32 of the cover plate 30, and the oil nozzle seat 40 is fixed, and thus the oil nozzle A can be disassembled from the oil nozzle seat 40 and can be rotated to a desired angle.

To summarize, an adjusting structure for an oil feeding device of a linear guideway in accordance with the present invention comprises: an oil scraping piece, an end cap, a cover plate and an oil nozzle seat. The oil nozzle seat is provided for positioning an oil nozzle, and the oil nozzle seat is fixed on the end cap. The second positioning portion of the oil nozzle cooperates with the first positioning portion of the end cap to enable the oil nozzle seat to be movable or rotatable or positioned relative to the end cap, allowing the user to adjust the feeding angle of the oil nozzle.

While we have shown and described various embodiments in accordance with the present invention, it is clear to those skilled in the art that further embodiments may be made without departing from the scope of the present invention.

What is claimed is:

1. An adjusting structure for an oil feeding device of a linear guideway, comprising: an end cap and an oil nozzle, the end cap being assembled on a slide block, and the oil nozzle being assembled on the end cap; the adjusting structure is characterized in that:
the end cap is formed in a side thereof with a through hole, a first positioning portion is radially formed in the through hole; and
the oil nozzle is threaded in one end of the oil nozzle seat, and at another end of the oil nozzle seat is radially formed a second positioning portion, the oil nozzle seat is inserted in the through hole of the end cap, and the second positioning portion of the oil nozzle seat is positioned in the first positioning portion of the end cap.

2. The adjusting structure for an oil feeding device of a linear guideway as claimed in claim 1, wherein the first positioning portion of the end cap includes a plurality of tooth-shaped portions annularly arranged around the through hole.

3. The adjusting structure for an oil feeding device of a linear guideway as claimed in claim 2 further comprising an oil scraping piece with a through hole, and the through hole of the oil scraping piece is aligned to the through hole of the end cap, and the oil scraping piece is assembled on a side of the end cap.

4. The adjusting structure for an oil feeding device of a linear guideway as claimed in claim 3 further comprising a cover plate with a concave, in a bottom of the concave is formed a positioning hole, the concave of the cover plate is aligned to the through hole of the oil scraping piece, and then the cover plate is assembled to another side of the end cap.

5. The adjusting structure for an oil feeding device of a linear guideway as claimed in claim 1, wherein the oil nozzle seat is a stepped columnar structure, in one end of an interior of the oil nozzle seat is formed a threaded hole with a comparatively large inner diameter, and in the other end of the interior of the oil nozzle seat is formed a connecting hole with a comparatively small inner diameter, the threaded hole is provided for engaging with the oil nozzle, at a connecting portion between the threaded hole and the connecting hole is formed a stopping surface located opposite the first positioning portion of the end cap, the oil nozzle seat is formed on its outer periphery with an abutting surface located opposite one end of the oil nozzle.

6. The adjusting structure for an oil feeding device of a linear guideway as claimed in claim 5, wherein the second positioning portion of the oil nozzle seat is formed in the shape of the first positioning portion of the end cap, on another side of the second positioning portion of the oil nozzle seat is formed an axial positioning rib formed in the shape of the positioning hole of the cover plate.

7. The adjusting structure for an oil feeding device of a linear guideway as claimed in claim 6, wherein the second positioning portion of the nozzle seat is formed with a single tooth, and the second positioning portion of the nozzle is formed in the shape of the single-tooth shaped first positioning portion of the end cap.

8. The adjusting structure for an oil feeding device of a linear guideway as claimed in claim 1, wherein the first positioning portion is a tooth-shaped groove annularly formed in a side surface of the end cap and is aligned to the concave of the cover plate, and the second positioning portion of the oil nozzle seat is formed in the shape of the first positioning portion of the end cap.

9. The adjusting structure for an oil feeding device of a linear guideway as claimed in claim 6, wherein the first positioning portion is a tooth-shaped groove annularly formed in a side surface of the end cap and is aligned to the concave of the cover plate, and the second positioning portion of the oil nozzle seat is formed in the shape of the first positioning portion of the end cap.

10. The adjusting structure for an oil feeding device of a linear guideway as claimed in claim 8, wherein the oil nozzle seat is a stepped columnar structure.

11. The adjusting structure for an oil feeding device of a linear guideway as claimed in claim 9, wherein the oil nozzle seat is a stepped columnar structure.

12. The adjusting structure for an oil feeding device of a linear guideway as claimed in claim 1, wherein the first positioning portion of the end cap includes a plurality of semi-circular cavities annularly arranged around the through hole of the end cap, and the second positioning portion of the oil nozzle seat is formed in the shape of the first positioning portion of the end cap.

13. The adjusting structure for an oil feeding device of a linear guideway as claimed in claim 6, wherein the first positioning portion of the end cap includes a plurality of semi-circular cavities annularly arranged around the through hole of the end cap, and the second positioning portion of the oil nozzle seat is formed in the shape of the first positioning portion of the end cap.

14. The adjusting structure for an oil feeding device of a linear guideway as claimed in claim 12, wherein the oil nozzle seat is a stepped columnar structure.

15. The adjusting structure for an oil feeding device of a linear guideway as claimed in claim 13, wherein the oil nozzle seat is a stepped columnar structure.
